(19) United States
(12) Patent Application Publication
(10) Pub. No.: US 2004/0010795 A1
(43) Pub. Date: Jan. 15, 2004

(54) Device driver installing program and device driver installing apparatus

(75) Inventors: Takashi Sasaki, Kawasaki (JP); Masanori Sakai, Kawasaki (JP); Toru Taguchi, Kawasaki (JP); Emiko Kawai, Kawasaki (JP); Mitsuhiro Kemmotsu, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/352,068

(22) Filed: Jan. 28, 2003

(30) Foreign Application Priority Data
Jul. 12, 2002 (JP) 2002-204059

(51) Int. Cl. G06F 13/10; G06F 9/00

(52) U.S. Cl. 719/321; 719/327

(57) ABSTRACT

A device driver installing program and a device driver installing apparatus for enhancing functions of a client/server system, by dynamically installing device drivers adapted to hardware of a client when the client is started, and also dynamically installing device drivers of external storages adapted to an authorization for a user group when user's log-in is made.

### FIELD OF THE INVENTION

The present invention relates to a technique for dynamically installing device drivers adapted to hardware of a client computer (hereinafter to be referred to as “client”) in a client/server system.

### RELATED ART OF THE INVENTION

In recent years, there has been practiced a “thin client system” in which each client is allowed to have only minimum functions while sources such as application software and files, are managed by a server computer (hereinafter to be referred to as “server”). In such a thin client system, there has been a demand for utilizing, as the client, not only a dedicated terminal equipped with such only minimum functions, but also an inexpensive and high-performance PC (Personal Computer).

However, when starting a PC, it is required to install, into the PC, device drivers adapted to hardware such as a video card, sound card, keyboard, mouse and the like. Installation of device drivers in case of UNIX (Registered Trademark) is required to be previously defined by a system setting file “XF86Config”. On the contrary, the thin client system has a concept in that a client becomes available immediately after the client is connected to a computer network. Therefore, if a PC having different hardware, it is extremely difficult to construct a thin client system since the installation of device drivers cannot be previously defined.

Further, external storages such as floppy disk drive, CD-ROM drive, MO drive and the like, are frequently installed in a PC. Although clients in a conventional thin client system are not installed with external storages for prevent information leakage, there has arisen a demand for allowing specific users to use external storages in the case where PCs are used as clients of the thin client system. However, in order to use external storages, since it is required to install device drivers thereof, it has been impossible to inhibit or allow the use of external storages corresponding to the authorization for the user.

The present invention has been accomplished in view of the conventional problems as described above, and it is therefore an object of the present invention to provide a technique for enhancing functions of a client/server system by dynamically installing device drivers adapted to hardware when starting a client while dynamically installing device drivers of external storages adapted to authorization for a user at user's log-in.

### SUMMARY OF THE INVENTION

In order to achieve the above object, according to a device driver installing technique of the present invention, when a client connected to a computer network is started, a program is transferred from a server to the client, for querying the server about device information adapted to hardware specified by product name information about the client and dynamically installing device drivers necessary for the client, based on the device information returned from the server. Then, on the client side, a query is made to the server about the device information, with the product name information held in BIOS as a parameter, for example. When the device information is returned from the server to the client, the device drivers recorded and held in the server are installed into the client, based on a setting file created according to the returned device information. At this time, the device drivers are desirably related to a video card, a sound card, a keyboard and a mouse that are minimally required for starting an X Window System in UNIX (Registered Trademark), for example.

According to such a constitution, in starting the client, the device drivers adapted to the hardware specified by the product name information are dynamically installed into the client. Thus, it becomes unnecessary to previously install device drivers adapted to the client, thereby enabling to construct a client/server system using a plurality of personal computers as clients. Further, it becomes possible to utilize existing personal computers, to thereby reduce the cost required for constructing the client/server system. At this time, if the product name information held in the BIOS of the client is used, it is possible to readily specify such product name information even in the case where personal computers constituted of various hardware are utilized as the clients.

On the other hand, on the server side, a database in which hardware corresponding to the product name information and the device information about the hardware are defined, respectively, may be retrieved to determine the device information adapted to the hardware specified by the product name information. In this way, it is possible to readily determine the device information while suppressing an increase of processing burden in the server, by suitably designing the database.

Further, when user's log-in is made in the client, a program is transferred from the server to the client, for querying the server about an authorization for a user group to use external storages specified by a user identifier, and device information of the external storages, and for dynamically installing device drivers of the external storages of the user group into the client, based on the authorization to use the external storages and based on the device information of the external storages, both returned from the server. Then, at the client side, when a response to the query with the user identifier as a parameter is returned from the server, the device drivers recorded and held in the server are installed into the client, based on a setting file created according to the authorization to use the external storages and according to the device information about the external storages.

According to such a constitution, if the user's log-in is made in the client, the device drivers of the external storages authorized to be used are dynamically installed, based on the authorization for the user group to use the external storage specified by the user identifier, and based on the device information about the external storages. Thus, it becomes possible to dynamically install the device drivers of the external storages adapted to the user group, to exclusively allow specific users to use predetermined external storages.

On the other hand, on the server side, a database in which the external storages authorized to be used for the user group, and the device information about the external storages, are defined respectively, is retrieved to determine the external storages authorized to be used for the user group specified by the user identifier, and the device information about the external storages. In this way, it becomes possible to readily determine the external storages authorized for the user group to use, and the device information about the external storages, respectively, while suppressing an increase of processing burden in the server, by suitably designing the database.

Other objects and aspects of the present invention will become apparent from the following description of preferred embodiments when read in conjunction with the accompanying drawings.

### BRIEF EXPLANATION OF THE DRAWINGS

FIG. 1 is a block diagram of a thin client system constructed by applying the present invention;

FIG. 2 is an explanatory view showing a process when a client is started;

FIG. 3 is an explanatory view of a hardware.bt file provided in a managing server;

FIG. 4 is an explanatory view of a kerneldriver.bt file provided in the managing server;

FIG. 5 is an explanatory view of an option.bt file provided in the managing server;

FIG. 6 is an additional explanatory view of the option.bt file provided in the managing server;

FIG. 7 is an explanatory view of device information created by the managing server;

FIG. 8 is an explanatory view of a system setting file created by a client;

FIG. 9 is an additional explanatory view of the system setting file created by the client;

FIG. 10 is an explanatory view of a setting file created by the client;

FIG. 11 is an explanatory view of a process when a user's log-in is made;

FIG. 12 is an explanatory view of a group.bt file provided in the managing server;

FIG. 13 is an explanatory view of group device information created by the managing server;

FIG. 14 is an explanatory view of a setting file created by the client;

FIG. 15 is an explanatory view of a printer setting file created by the client; and

FIG. 16 is an explanatory view of a shell script created by the client.

### PREFERRED EMBODIMENT

The present invention will be described in detail hereinafter with reference to the accompanying drawings.

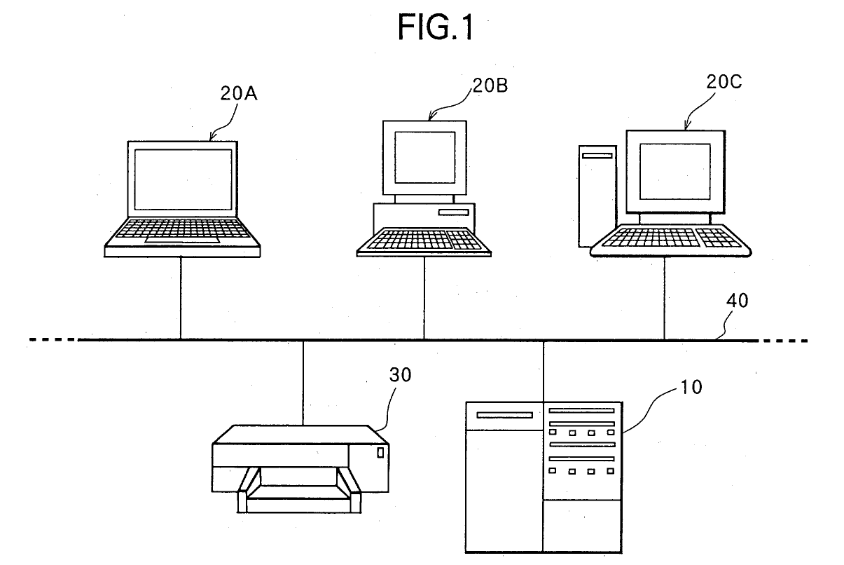

FIG. 1 shows a thin client system constructed by applying the present invention to a client/server system.

The thin client system comprises a managing server 10, at least one client 20 (20A through 20C) and a network printer 30. The client 20 includes, in addition to conventional dedicated terminals, a PC equipped with external storages such as a floppy disk drive, CD-ROM drive, MO drive and the like. The managing server 10, client 20 and network printer 30 are interconnected via a computer network 40 such as an Ethernet (Registered Trademark).

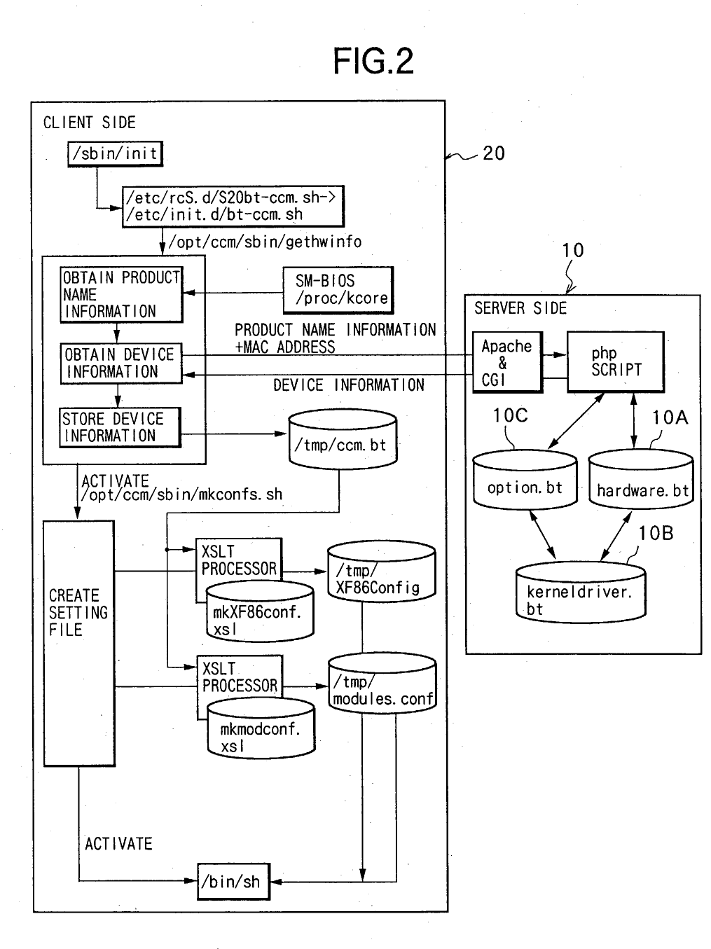

Next, there will be described hereinafter a process to be executed when the client is started, with reference to FIG. 2. In the description hereinafter, it is assumed that Linux of UNIX (Registered Trademark) system is used as an OS (Operating System) in a system.

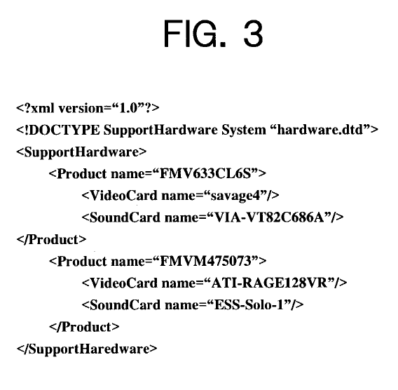

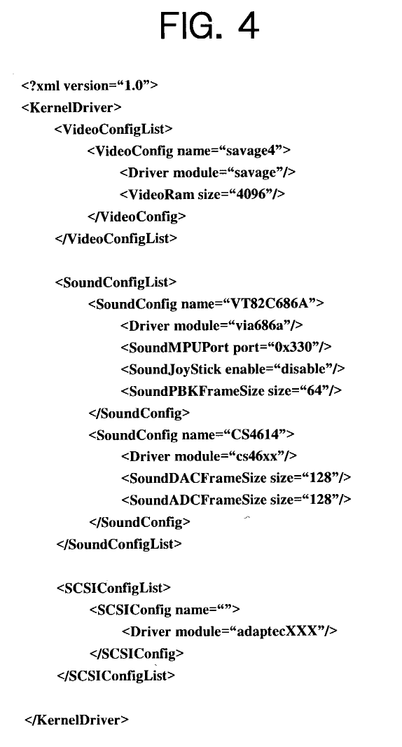

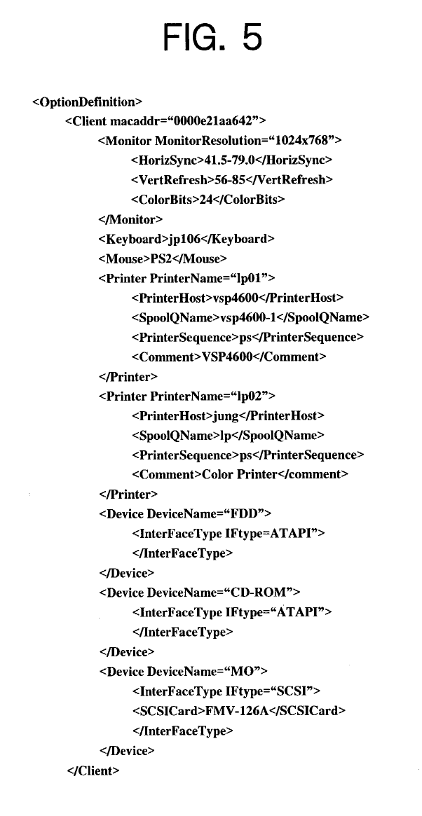

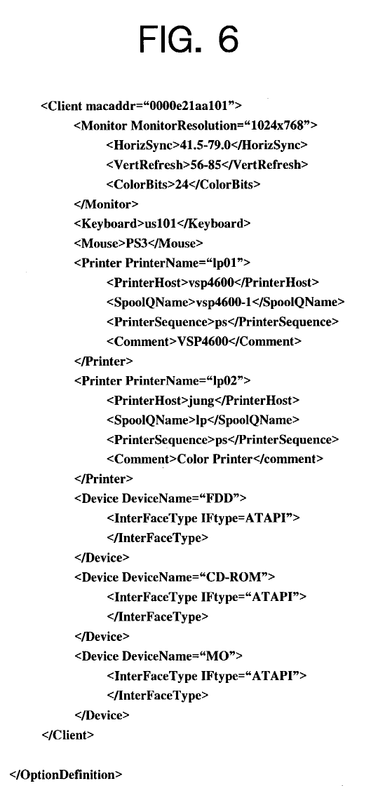

The managing server 10 is provided with a hardware.bt file 10A, a kerneldriver.bt file 10B and an option.bt file 10C, as various database. In the hardware.bt file 10A, as shown in FIG. 3, there are defined associations of PC product name with a video card and sound card, respectively, by using an XML (Extensible Markup Language) format. (The same rule applies correspondingly to the following, concerning the adoption of the XML format.) In the kerneldriver.bt file 10B, as shown in FIG. 4, there are defined associations of the video card, sound card and an SCSI (Small Computer System Interface) card with device drivers and parameters thereof. In the option.bt file 10C, as shown in FIGS. 5 and 6, there are defined associations of the client 20 specified by an MAC (Media Access Control) address with monitor information, keyboard, mouse, network printer, and external storages (such as FDD, CD-ROM and MO). Here, resolutions, frequencies and displayable colors are set as the monitor information, respectively. The product name is set as keyboard or mouse. A printer host and a spool que name are set as the network printer, respectively. An interface type and the like are set as the external storages, respectively. Note, in the option.bt file 10C, the hardware of client 20 may be specified by the PC product name instead of MAC address.

When source power is supplied to the client 20, the client 20 is mounted into an NFS (Network File System) by an activation script (/etc/rcS.d/S20bt-ccm.sh->/etc/init.d/bt-ccm.sh) called from a /sbin/init, so that the client 20 is connected to the managing server 10. When the mount into the NFS is completed, it becomes possible for the client 20 to handle sources such as programs, device drivers and files managed by the managing server 10, as if those of the client 20 itself. Note, although the client 20 is shown in the figure to have various functions, in order to clarify function allotment between the client side and server side, such functions are transferred from the managing server 10 to the client 20 in fact (the same rule shall be applied in the following). Here, the process of mounting the client 20 into the NFS realizes a first program transferring function, a second program transferring function, first program transferring means and second program transferring means.

When a command (/opt/ccm/sbin/gethdinfo) for obtaining hardware information about the PC is called from the activation script, product name information about the PC being the client is read out from an SM-BIOS (System Management BIOS) of the PC's motherboard. Note, in the kernel 2.4 of Linux, since information of SM-BIOS is held in a /proc/kcore, the product name information may be read out therefrom. When the product name information is obtained, device information is queried to the managing server 10 with the product name information and MAC address, as parameters, via http (HyperText Transfer Protocol).

In the managing server 10 having received the query about the device information, there is called a php (Professional HTML Preprocessor) script, through an Apache being an http server program and through a CGI (Common Gateway Interface). The called php script retrieves the hardware.bt file 10A, kerneldriver.bt file 10B and option.bt file 10C, to thereby extract the hardware information and device drivers thereof (hereinafter to be referred to as “device information”) adapted to the product name information.

When the product name information is “FMV633CL6S”, the hardware.bt file 10A shown in FIG. 3 is retrieved, to thereby extract a video card “savage4” and a sound card “VIA-VT82C686A” corresponding to the Product name=“FMV633CL6S”. Next, the kerneldriver.bt file 10B shown in FIG. 4 is retrieved, to thereby extract device driver information “savage” and its parameter “4096” corresponding to the video card “savage4” as well as device driver information “via686a” and its parameter “0x330” corresponding to the sound card “VT82C686A”. Further, the option.bt file 10C shown in FIGS. 5 and 6 is retrieved, to thereby extract the monitor information, keyboard information “jp106” and mouse information “PS2”, that are specified by MAC address “0000e21aa642”.

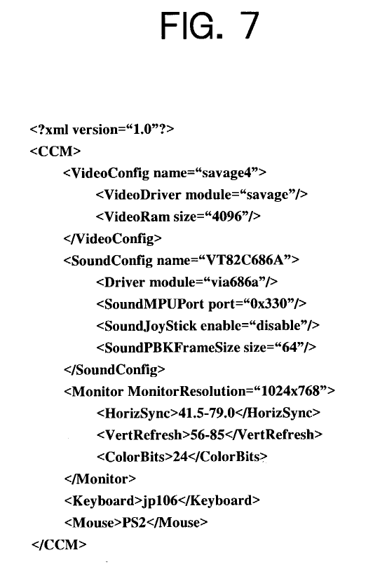

Then, based on the extracted device information, a device information file “ccm.bt” described in the XML format, as shown in FIG. 7, is created, to be returned to the client 20 via http. Here, the process of returning the device information to the client 20 realizes a first device information returning function and first device information returning means.

The client 20 having received the device information file stores it into a directory “/tmp”, for example.

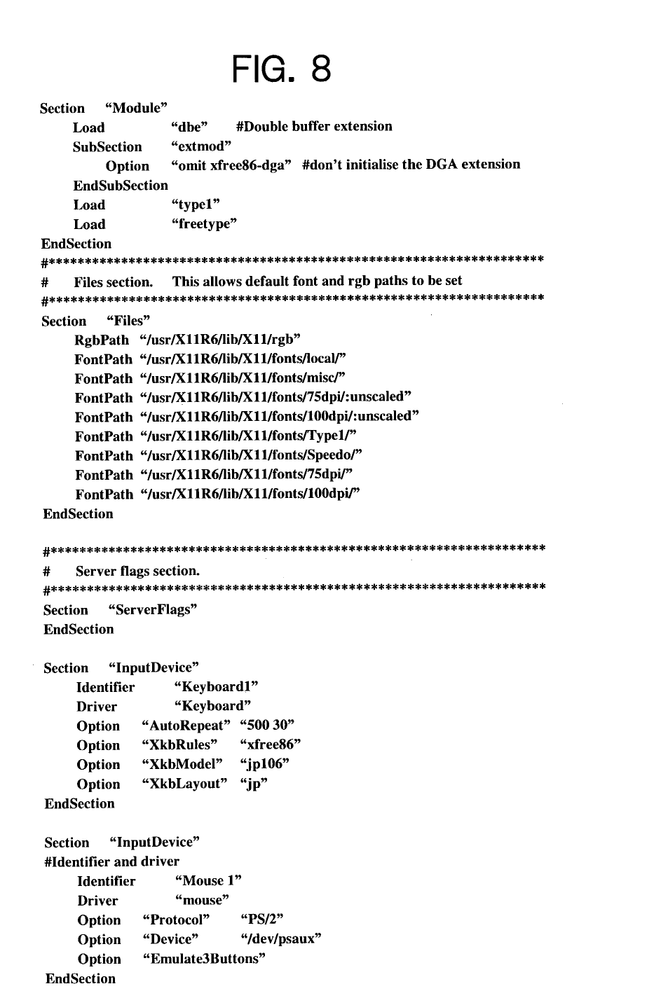

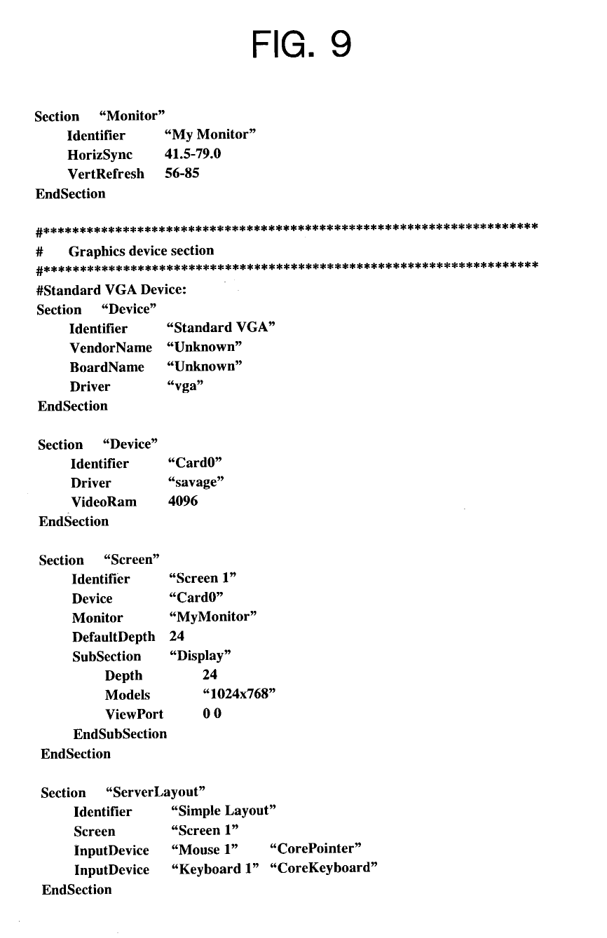

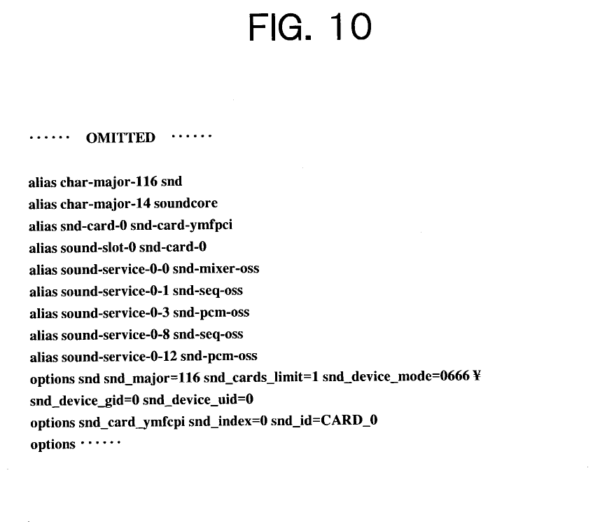

Subsequently to the execution of the command for obtaining the hardware information about the PC, a shell script (/opt/ccm/sbin/mkconfs.sh) for creating a setting file is called, to thereby create a system setting file “XF86Config” (see FIGS. 8 and 9) and a setting file “modules.conf” (see FIG. 10) for loading kernel modules. Namely, an XSLT (xsl Transformations) processor is activated with the device information file “/tmp/ccm.bt” and xsl (Extensible Stylesheet Language) files “mkXF86Confs.xsl” and “mkmodconfs.xsl” being templates of the setting file, as parameters, to thereby create the system setting file “XF86Config” and the setting file “modules.conf”. Here, it is possible to utilize a TransforMiix of the Mozilla.org or an Xalan of the Apache.org, as the XSLT processor.

When the creation of the setting files is completed, the device drivers required for starting the client 20 are installed in a B shell (/bin/sh), based on the system setting file “XF86Config” and the setting file “modules.conf”.

According to the above described process, when the client 20 is started, the product name information about the client 20 is obtained from the SM-BIOS of the PC. Then, the device information is queried to the managing server 10 with the obtained product name information and the MAC address as parameters. In the managing server 10 having received the query about the device information, the device information adapted to the hardware of the PC is created based on the product name information and the MAC address, and returned to the client 20. Then, in the client 20 having received the device information, the XSLT processor is activated, to thereby create the system setting file “XF86Config” and setting file “modules.conf”. Further, by activating an X Window System based on these setting files, the device drivers adapted to the hardware of the PC are dynamically installed.

Thus, it becomes unnecessary to previously install device drivers adapted to the hardware of the client 20, thereby enabling to construct a thin client system using a various types of PC's. Therefore, it is also possible to utilize existing PC's, to thereby reduce the cost required for constructing the thin client system.

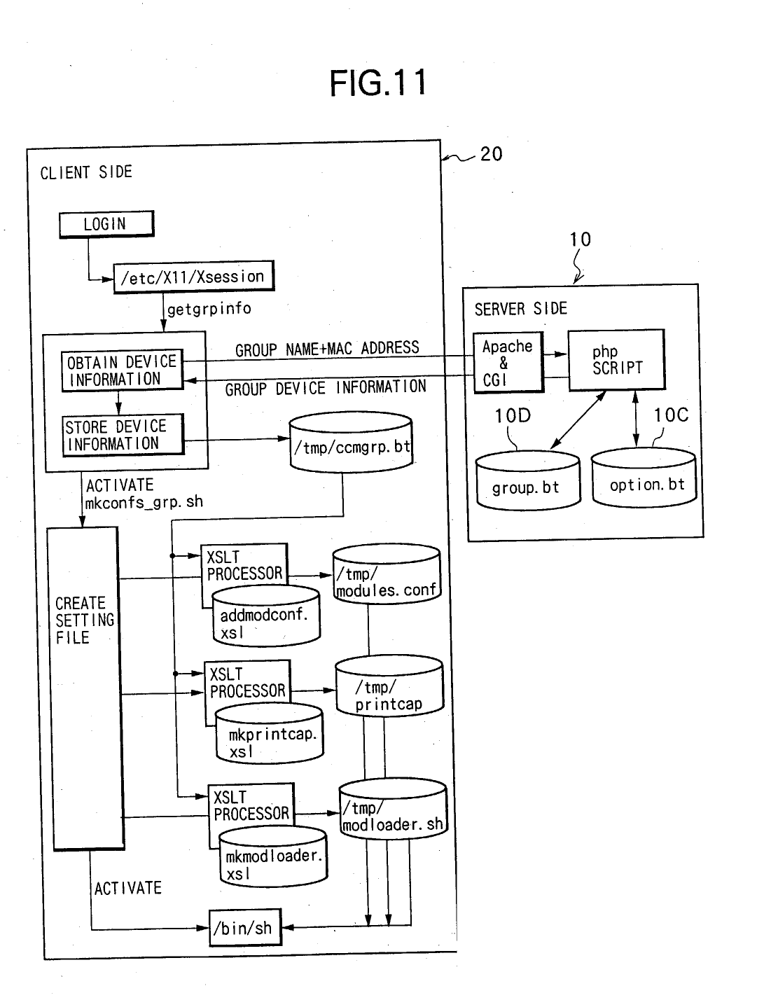

FIG. 11 shows a process to be executed when user's log-in is made, in the thin client system.

The managing server 10 is further provided with a group.bt file 10D as the various database, in addition to the option.bt file 10C. In the group.bt file 10D, there are defined associations of user groups (inclusive of groups each including only a single user) with available network printers and external storages, as shown in FIG. 12. In the example shown in the figure, it is defined that users belonging to a UserGroup=“btusers” can use printers “Ip01” and “Ip02” as the network printers, and devices “FDD”, “CD-ROM” and “MO” as the external storages. When any of these devices is not available to use, a DeviceIsUsed tag of such a device is set to be “false”.

Then, when the user's log-in is made by entering a group name, in a shell script (/etc/X11/Xsession) to be executed at log-in, there is called a command (getgrpinfo) for obtaining group device information adapted to the user group. Consequently, the group device information is queried to the managing server 10 with the group name and MAC address as parameters, via http.

In the managing server 10 having received the query about the group device information, there is called the php script, through the Apache and the CGI. The called php script retrieves the option.bt file 10C and group.bt file 10D, to thereby extract the group device information about the network printers and external storages, the use of which by the user group specified by the group name are permitted or inhibited.

When the group name is “btusers”, the group.bt file 10D shown in FIG. 12 is retrieved, to thereby extract use permission information about the network printers and external storages for the user group specified by the UserGroup=“btusers”. Further, the option.bt file 10C shown in FIGS. 5 and 6 is also retrieved, to thereby extract local printer information and interface information about the external storages and the like, that are specified by the MAC address “0000e21aa642”.

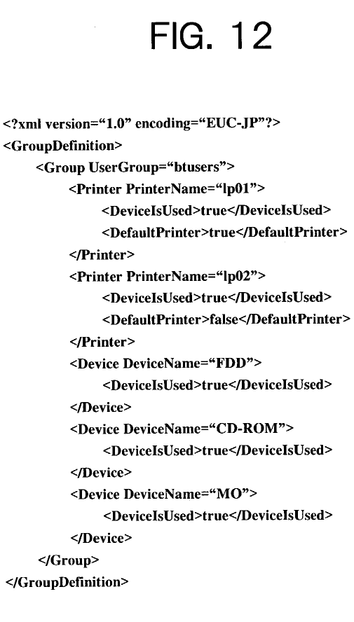

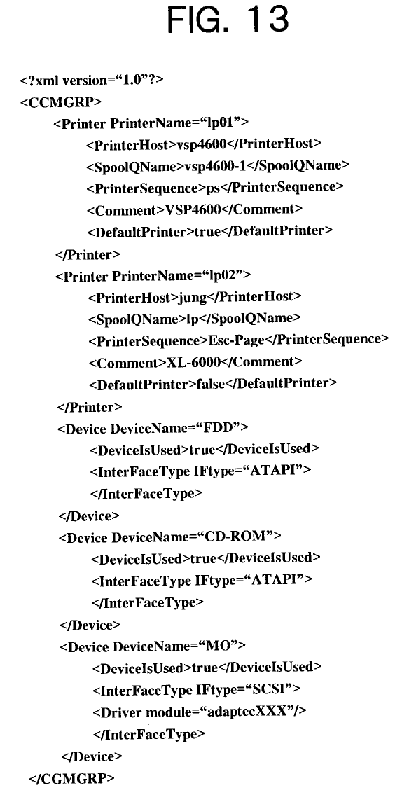

Then, based on the extracted use permission information and the like, there is created a group device information file “ccmgrp.bt” described in the XML format, as shown in FIG. 13 and returned to the client 20 via http. Here, the function for returning the group device information file to the client 20 realizes a second device information returning function and second device information returning means.

The client 20 having received the group device information file stores it into the directory “/tmp”, for example.

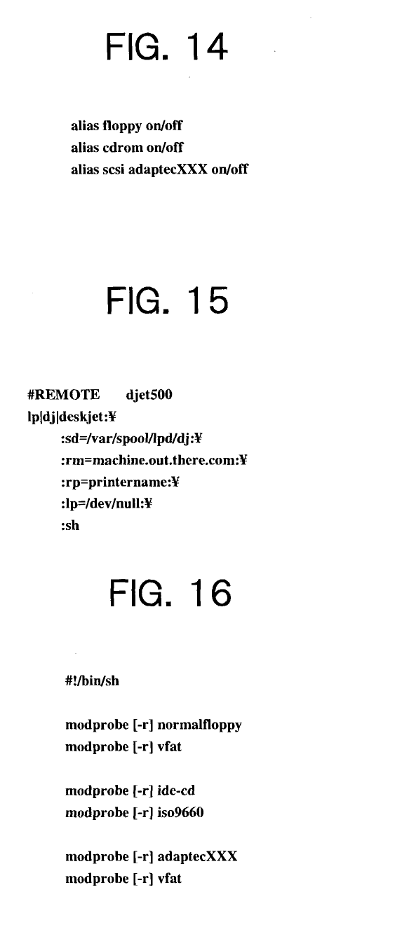

Subsequently to the execution of a command for obtaining the group device information, there is called a shell script (mkconfs_grp.sh) for creating a setting file “modules.conf” (see FIG. 14) for loading kernel modules, a setting file “printcap” (see FIG. 15) for local printers and a shell script “modloader.sh” (see FIG. 16) for executing an installing/uninstalling process of the device drivers of the external storages. Then, the XSLT processor is activated with the group device information file “/tmp/ccmgrp.bt”, xsl files “addmodconf.xsl”, “mkprintcap.xsl” and “mkmodloader.xsl” being templates of the setting file and the shell script, as parameters, to thereby create the setting files “modules.conf” and “printcap” and the shell script “modloader.sh”.

When the creation of the setting files and shell script is completed, in the B shell (/bin/sh), there is performed the setting for loading kernel modules and for local printers based on the setting files “modules.conf” and “printcap”, respectively. Further, based on the shell script “modloader.sh”, there is called a modprobe command to thereby install the device drivers adapted to the floppy disk drive, CD-ROM drive, MO drive and the like as the external storages permitted to use. At this time, if device drivers of the external storages not permitted to use have been already installed at that time, those device drivers are uninstalled. Note, all the device drivers may be uninstalled, before installing the device drivers permitted to use.

According to the above described process, when the user's log-in is made, the group device information about the network printers and external storages is queried to the managing server 10 with the group name of the user and the MAC address as parameters. In the managing server 10 having received the query about the group device information, there is created group device information including the use permission of the network printers and external storages based on the group name and MAC address, and returned to the client 20. In the client 20 having received the group device information, the XSLT processor is activated to create the setting files “modules.conf” and “printcap” and the shell script “modloader.sh”. Then, based on the setting files “modules.conf” and “printcap”, there are performed the setting for loading kernel modules and for local printers. Further, based on the shell script “modloader.sh”, there is called the modprobe command to thereby dynamically install the device drivers adapted to the external storages permitted to use.

Consequently, at the time of user's log-in, it is possible to dynamically install the device drivers of external storages adapted to the pertinent user group, to thereby allow only specific users to use the pertinent external storages.

What is claimed are:

1. A device driver installing program which operates in a server connected with a client via a network, for realizing in said server:
a first program transferring function for transferring, to said client when the client is started, a program that is recorded and held in the server, for realizing functions in said client for: obtaining product name information about the client; querying the server about device information adapted to hardware specified by said product name information with the obtained product name information as a parameter; and dynamically installing device drivers necessary for the client from the server into the client, based on the device information returned from the server, and
a first device information returning function for returning the device information adapted to the hardware specified by said product name information to the client, when said device information is queried to the server.

2. A device driver installing program according to claim 1,
wherein said function for dynamically installing device drivers necessary for the client into the client creates a setting file for installing the device drivers into the client, based on the device information returned from said server, and installs the device drivers recorded and held in the server, based on the created setting file.

3. A device driver installing program according to claim 1,
wherein said first device information returning function retrieves a database in which hardware corresponding to the product name information and the device information about the hardware are defined, respectively, to determine device information adapted to the hardware specified by the product name information.

4. A device driver installing program according to claim 1,
wherein the device drivers required for starting the client are related to a video card, a sound card, a keyboard and a mouse.

5. A device driver installing program according to claim 1,
wherein product name information held in a BIOS of said client is used, as said product name information.

6. A device driver installing program according to claim 1, further realizing in said server:
a second program transferring function for transferring, to said client when user's log-in is made, a program that is recorded and held in the server, for realizing functions in said client for: querying the server about an authorization to use external storages for a user group specified by a user identifier, and device information of the external storages, with said user identifier as a parameter; and dynamically installing device drivers of the external storages the use of which is authorized to the user group into the client, based on the authorization to use the external storages and based on the device information of the external storages, both returned from the server, and
a second device information returning function for returning said authorization for the user group specified by said user identifier to use the external storages, and said device information about the external storages to the client, when said authorization to use the external storages and said device information about the external storages are queried to the server.

7. A device driver installing program according to claim 6,
wherein said function for dynamically installing device drivers of the external storages the use of which is authorized to the user group, creates a setting file for installing the device drivers into the client, based on said authorization to use the external storages and based on said device information about the external storages, both returned from the server, to install device drivers recorded and held in the server, based on the created setting file.

8. A device driver installing program according to claim 6,
wherein said second device information returning function retrieves a database in which external storages the use of which is authorized to the user groups, and device information about the external storages, are defined, respectively, to determine an authorization for the user group specified by said user identifier to use the external storages, and the device information about the external storages.

9. A device driver installing apparatus, comprising:
first program transferring means for transferring, to a client connected to a server via a network when said client is started, a program that is recorded and held in the server, for realizing functions in said client for: obtaining product name information about the client; querying the server about device information adapted to hardware specified by said product name information with the obtained product name information as a parameter; and dynamically installing device drivers necessary for the client from the server into the client, based on the device information returned from the server, and
first device information returning means for returning the device information adapted to the hardware specified by said product name information to the client, when said device information is queried to the server.

10. A device driver installing apparatus according to claim 9, further comprising:
second program transferring means for transferring, to said client when user's log-in is made, a program that is recorded and held in the server, for realizing functions in said client for: querying the server about an authorization to use external storages for a user group specified by a user identifier, and device information of the external storages, with said user identifier as a parameter; and dynamically installing device drivers of the external storages the use of which is authorized to the user group into the client, based on the authorization to use the external storages and based on the device information of the external storages, both returned from the server, and
second device information returning means for returning said authorization for the user group specified by said user identifier to use the external storages, and said device information about the external storages to the client, when said authorization to use the external storages and said device information about the external storages are queried to the server.
